(19) United States
(12) Patent Application Publication
(10) Pub. No.: US 2005/0160541 A1
(43) Pub. Date: Jul. 28, 2005

(54) Power toothbrush

(76) Inventor: Henry Goldfine, Edison, NJ (US)

Correspondence Address: COLGATE-PALMOLIVE COMPANY, 909 RIVER ROAD, PISCATAWAY, NJ, 08855, US

(21) Appl. No.: 11/083,472

(22) Filed: Mar. 18, 2005

Related U.S. Application Data
(63) Continuation of application No. PCT/US03/29492, filed on Sep. 17, 2003.
(60) Provisional application No. 60/412,292, filed on Sep. 20, 2002.

(51) Int. Cl. A61C 17/22

(52) U.S. Cl. 15/22.1

(57) ABSTRACT

A power operated toothbrush comprises a hollow handle and a head mounted to the handle. A power drive assembly is in the handle operatively connected to a movable section in the head for moving that section. Cleaning elements extend outwardly from the movable section. A bumper is secured to the peripheral side wall of the head. The bumper is made of a soft yieldable material to prevent injury to the teeth and gums and to act as a cushion to minimize high intensity vibration and to deaden sound which would result during use of the power operated toothbrush.

### BACKGROUND OF THE INVENTION

In general two types of toothbrushes are commonly used. One type is a manual toothbrush where the user simply holds the toothbrush handle and brushes by inserting the toothbrush head into the mouth and then moving the head by moving the handle. Another type of toothbrush is a power operated toothbrush which includes at least one movable section power driven so that when the toothbrush is inserted into the mouth there is movement of the moving section as a result of the power drive. Power toothbrushes generally have the characteristics of high intensity vibration because of the moving section as well as the creation of added noise or sound. It has been suggested in the prior art such as in U.S. Pat. No. 6,192,544 to provide a manual toothbrush with a protective bumper made of a resilient material to prevent injury to the teeth and gums. Such manual toothbrushes, however, do not have the concerns attendant with power toothbrushes such as high intensity vibration and sound or noise.

### SUMMARY OF THE INVENTION

An object of this invention is to provide a power driven toothbrush with structure for cushioning high intensity vibration and for providing sound deadening properties as well as preventing injury to the teeth and gums during use of the toothbrush.

In accordance with this invention a power driven toothbrush includes at least one movable section in the head of the toothbrush. A power drive assembly is mounted in the hollow handle of the toothbrush operatively connected to the movable section for imparting a movement to the movable section. The movable section includes cleaning elements such as bristles extending outwardly from the outer surface of the head. A bumper made of soft yieldable material is secured to the peripheral side wall of the head. The bumper is preferably made of a material softer than the material of the head itself. In addition, the bumper is preferably in the form of a single continuous member extending from one side of the handle completely around the head to the other side of the handle. The bumper preferably completely covers the peripheral side wall of the head extending to the outer cleaning element carrying surface of the head.

The bumper may be permanently attached to the head. Alternatively, the bumper may be detachably attached so that the bumper can be selectively replaced by a different bumper having the same shape, color or other characteristics as the previous bumper or having a different shape and/or color and/or characteristics as the previous bumper.

### THE DRAWINGS

FIG. 1 is a front elevational view showing a power toothbrush in accordance with this invention;

FIG. 2 is a side elevational view of a modified form of power toothbrush in accordance with this invention;

FIG. 3 is a cross-sectional view taken through FIG. 1 along the line 3-3; and

FIGS. 4-5 are views similar to FIG. 3 of alternative embodiments of this invention.

### DETAILED DESCRIPTION

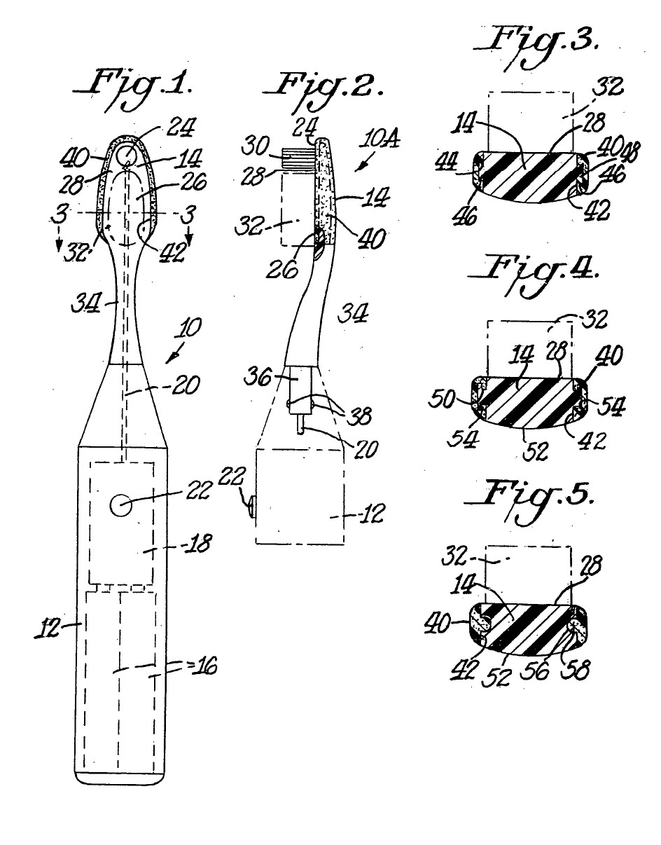

FIG. 1 illustrates a power driven toothbrush 10 in accordance with this invention. As shown therein toothbrush 10 includes a hollow handle 12 and a head 14. Handle 12 houses a power drive assembly or power system which is shown in phantom as including a set of batteries 16 for powering a motor 18 which in turn drives a shaft 20. An on-off button 22 is provided to actuate the drive assembly. Shaft 20 is operatively connected to a movable section 24 on head 14. Section 24 may occupy essentially the entire area of head 14. Alternatively, as illustrated, a further section 26 is included on head 14. Each of the movable section 24 and the further section 26 includes cleaning elements extending outwardly from the outer surface 28 of head 14. FIG. 2 shows, for example, bristles 30 which would extend outwardly from movable section 24 while cleaning elements such as bristles 32 would extend outwardly from the other section 26. Section 26 could be a second movable section or could be a fixed section.

In the embodiment shown in FIG. 1, head 14 is permanently mounted to handle 12. FIG. 2 shows a variation where head 14 is detachably mounted to handle 12 of toothbrush 10A in any suitable manner. In the illustrated form head 14 includes a neck 34 having a coupler extension 36 for detachable connection to shaft 20. The shaft may be connected or disconnected by depressing spring loaded detents 38. It is to be understood that the form of detachable connection shown in FIG. 2 is merely for exemplary purposes. Any other suitable known structure may be used for detachably mounting head 14 to handle 12.

In accordance with this invention the head 14 includes a bumper 40 which is preferably made of a soft yieldable elastomer material softer than the material used for forming the head 14 itself. Thus, for example, head 14 could be made of any conventionally used hard plastic material such as polypropylene. Bumper 40, however, would be made of a material which is resilient and soft having, for example, a hardness of Shore A 30 or less. The hardness may also be Shore A 13 or less and may be 10-13. Examples of a suitable resilient and soft, thermoplastic elastomer that may be used for bumper 40 include a thermoplastic vulcanate (TPV) consisting of a mixture of polypropylene and EPDM (ethylene propylene diene monomers) which is available as SANTOPRENE (brand), described in U.S. Pat. No. 5,393,796, or VYRAM (brand), another TPV consisting of a mixture of polypropylene and natural rubber. Both SANTOPRENE and VYRAM (brands) are elastomers marketed by Advanced Elastomer Systems. Other suitable elastomers include KRATON, a brand of styrene block copolymer (SBC) marketed by Shell, and DYNAFLEX G 2706 (brand), a thermoplastic elastomer marketed by GLS Corporation and which is made with KRATON (brand) polymer.

In the preferred practice of this invention bumper 40 extends around the peripheral side wall 42 of head 14 from one side of handle 12 to the other side where neck 34 is considered as being part of the handle. Preferably, bumper 40 is made of one single continuous elastomeric member that covers the entire peripheral side wall 42 of head 14 extending completely to the outer cleaning element carrying surface 28.

Bumper 40 may be permanently attached to side wall 42 of head 14 in any suitable manner, including adhesive attachment or some form of welding such as ultrasonic welding or laser welding. With such permanent attachment the peripheral side wall 42 and the inner surface of bumper 40 may be coplanar without any surface interruptions to provide a smooth coplanar surface to surface connection. Alternatively, either or both of the peripheral side wall 42 or inner surface of bumper 40 may include channels, grooves, ridges, projections, etc. to provide an additional mechanical interlock.

The invention may also be practiced where bumper 40 is detachably mounted to peripheral side wall 42. In general, such detachable mounting would include a channel in head 14 which receives a projection from bumper 40. FIGS. 3-5 illustrate different possible manners of mounting bumper 40 to head 14. As shown in FIG. 3 peripheral wall 42 includes a pair of recesses or channels creating shoulders 44 which may be straight or may be inclined to form a dovetail. Bumper 40 is provided with projections or flanges 46 of complementary shape to shoulders 44 so that the resilient bumper 40 could be snapped over the shoulders 44 of the outward projection 48 of peripheral wall 42 to mount the bumper 40 to mount the bumper 40 in place by projections 46 being located in the recesses or channels formed in the outer wall 42 of head 14. Alternatively, the bumper 40 could be mounted by inserting one end of bumper 40 at neck 34 with flanges 46 against shoulders 44 and then sliding the bumper around the head 14 until bumper 44 is in its final position illustrated in FIG. 1.

Where bumper 40 is intended to be permanently mounted securing techniques could be used such as adhesive or welding in addition to the mechanical interlock to assure the permanent mounting. Alternatively, where bumper 40 is to be detachably mounted the mounting is easily achieved and the bumper is easily removed due to the resilient nature of the bumper material and the mechanical interlock by reversing the mounting steps.

FIG. 4 shows an alternative manner of mounting bumper 40. As shown therein, channels or recesses 50 are provided in the outer surface 28 and the opposed surface 52 of head 14. Bumper 40 is configured to fit over both surfaces 28 and 52. Accordingly, bumper 40 includes inwardly extending projections 54 for fitting into the recesses or channels 50. The peripheral side wall 42 would be disposed against the inner surface of bumper 40. Because of the resilient nature of bumper 40 each bumper may be stretched over and snapped into engagement with head 14. Alternatively, the bumper could be slid into engagement. Additional securing techniques may be used to effect a permanent mounting of bumper 40 to head 14 or the mounting may remain simply as a result of the resiliency and mechanical interlock of bumper 40 to head 14 so that bumper 40 can be detached when desired.

FIG. 5 illustrates yet another practice of this invention wherein the peripheral side wall 42 of head 14 includes a recess 56 which may be located generally midway the height of side wall 42 to receive a projection 58 from bumper 40. Thus bumper 40 becomes interlocked with head 14 by the engagement of projection 58 in recess or channel 56.

As shown in FIGS. 3 and 5 bumper 40 could be of a size and shape to provide a continuous outer surface extension of the surfaces 28 and 52 of head 14. Alternatively, bumper 40 could extend at least partially against the surfaces 28 and 52 as in the embodiment shown in FIG. 4. If desired, although less preferred, the bumper 40 could terminate short of outer surfaces 28 and/or 52, thus leaving a portion of side wall 42 exposed.

The cleaning elements provided on head 14 and in each section may be of any suitable form such as bristles or massage elements or other forms of cleaning elements such as elastomeric fingers or walls arranged in a circular cross-sectional shape or any other type of desired shape. Where bristles are used the bristles could be mounted to tuft blocks or sections by extending through suitable openings in the tuft blocks so that the base of the bristles is mounted within or below the tuft blocks. The cleaning elements could be provided in various combinations of the same or different cleaning element configurations and/or with the same bristle or cleaning element materials. The cleaning elements could be generally perpendicular to the outer surface 28 of head 14 or some or all of the cleaning elements may be angled at various angles with respect to the outer surface 28. It is thereby possible to select a combination of cleaning element configurations, materials and orientations to achieve specific intended results to deliver additional oral health benefits, like enhanced cleaning tooth polishing, tooth whitening and/or massaging of the gums.

The movable section 24 may oscillate in a rotational manner or may oscillate linearly in a longitudinal direction with respect to the longitudinal axis of the head or may oscillate linearly in a lateral or transverse direction with respect to the longitudinal axis of the head. The movable section may oscillate in and out in a direction toward and away from the outer surface of the head. The movable section may rock back and forth with respect to the outer surface of the head. The movable section may rotate continuously in the same direction, rather than oscillate. Any suitable drive mechanism may be used for imparting the desired motion to the movable section. Where plural movable sections are used, all of the movable sections may have the same type and direction of movement, or combinations of different movements may be used.

The movable section 24 could be oscillated rotationally such as by using the type of drive mechanism shown in U.S. Pat. No. 5,625,916, or could move in and out using the type of drive mechanism shown in U.S. Pat. No. Re35,941, all of the details of both patents are incorporated herein by reference thereto. Alternatively, the other types of drives referred to above could move section 24 in other manners and directions. Although FIG. 7 shows movable section 24 to be remote from the handle 12, the movable section(s) could be located at any desired location on the head.

Although movable section 24 is shown as being a circular disk the movable section may take other shapes. A circular disk is preferred where there is a rotational movement either by oscillating or rotating continuously in the same direction. Where the movement, however, is a linear oscillation or a rocking back and forth, noncircular elongated sections might be used.

The provision of a soft resilient bumper made of a yieldable material is particularly advantageous since it not only prevents injury to the soft oral tissue from the hard vibrating head, but also functions as a cushion to minimize the high intensity vibration of the movable section and to sound deaden the noise resulting from the power operated toothbrush.

The bumper 40 could be selected of a shape and color to add to the aesthetic appearance of the toothbrush. Where the bumper 40 is detachable sets of bumpers could be provided of different shapes and colors to give the user selectivity in combining the bumper and head.

1. A power toothbrush comprising a hollow handle, a head mounted to said handle, said head having an outer surface, cleaning elements mounted to said head extending outwardly from said outer surface, at least one section of said head being a movable section, at least some of said cleaning elements being on said movable section, a power drive assembly in said handle operatively connected to said movable section for moving said movable section, said head having a peripheral side wall, a bumper secured to said side wall, and said bumper being made of a soft yieldable material.

2. The toothbrush of claim 1 wherein said bumper is made of a material which is softer than the material of said head.

3. The toothbrush of claim 2 wherein said bumper extends continuously around said head from one side of said handle to the other side of said handle.

4. The toothbrush of claim 3 wherein said bumper is a one piece member which completely covers said peripheral side wall of said head, and said bumper extending to at least said outer surface of said head.

5. The toothbrush of claim 4 wherein said bumper is permanently mounted to said head.

6. The toothbrush of claim 4 wherein said bumper is detachably mounted to said head.

7. The toothbrush of claim 6 wherein said head includes at least one channel, and said bumper includes at least one projection mounted in said channel.

8. The toothbrush of claim 4 wherein said head includes at least one other section, and some of said cleaning elements being on said one other section.

9. The toothbrush of claim 1 wherein said bumper extends continuously around said head from one side of said handle to the other side of said handle.

10. The toothbrush of claim 1 wherein said bumper completely covers said peripheral side wall of said head, and said bumper extending to at least said outer surface of said head.

11. The toothbrush of claim 1 wherein said bumper is permanently mounted to said head.

12. The toothbrush of claim 11 wherein said bumper is detachably mounted to said head.

13. The toothbrush of claim 12 wherein said head includes at least one channel, and said bumper includes at least one projection mounted in said channel.

14. The toothbrush of claim 1 wherein said head includes at least one channel, and said bumper includes at least one projection mounted in said channel.

15. The toothbrush of claim 1 wherein said head includes at least one other section, and some of said cleaning elements being on said one other section.

16. The toothbrush of claim 14 wherein said at least one other section is non-movably mounted to said head.
